(19) United States
(12) Patent Application Publication
(10) Pub. No.: US 2016/0072325 A1
(43) Pub. Date: Mar. 10, 2016

(54) STATION FOR DISINFECTING AND CHARGING MULTIPLE PORTABLE ELECTRONIC DEVICES

(71) Applicant: AFC TRIDENT, INC., Ontario, CA (US)

(72) Inventors: Yi-Chieh SU, Chino, CA (US); Hong Lip YOW, Chino, CA (US)

(21) Appl. No.: 14/478,890

(22) Filed: Sep. 5, 2014

(51) Int. Cl. H02J 7/00

(52) U.S. Cl. CPC H02J 7/0044

(57) ABSTRACT

Provided is a system for holding a plurality of chargeable portable electronic devices having an enclosure providing a compartment. At least one tray is positioned in the compartment, wherein each tray includes a plurality of slots for receiving the portable electronic devices. A plurality of charging ports in the compartment enable charging of the chargeable portable electronic devices disposed within the slots. A germicidal source positioned in the compartment sterilizes a plurality of the chargeable portable electronic devices disposed in the slots when activated.

### BACKGROUND OF THE INVENTION

1. Field of the Invention

The present invention relates to a case and system for a station for disinfecting and charging multiple portable electronic devices

2. Description of the Related Art

As smartphones and tablets are deployed within larger organizations, there is a need to charge the devices for use. Prior art charging stations have been developed to charge multiple devices to provide a centralized location for charging multiple devices.

Large organizations deploying smartphones and tablets may also be concerned with sanitary conditions because smartphones and tablets are known to be major carriers of germs and other bacteria.

There is a need in the art for improved techniques for managing and maintaining multiple smartphones and tablet devices for personal and organizational uses.

### SUMMARY

Provided is a system for holding a plurality of chargeable portable electronic devices having an enclosure providing a compartment. At least one tray is positioned in the compartment, wherein each tray includes a plurality of slots for receiving the portable electronic devices. A plurality of charging ports in the compartment enable charging of the chargeable portable electronic devices disposed within the slots. A germicidal source positioned in the compartment sterilizes a plurality of the chargeable portable electronic devices disposed in the slots when activated.

Further provided is a system for holding a plurality of chargeable portable electronic devices having an enclosure providing a compartment. A first tray positioned in the compartment includes a plurality of first slots for receiving the portable electronic devices. A first charging component positioned in the compartment includes a plurality of charging ports to charge portable electronic devices located in the first slots. A first germicidal lamp is positioned in the compartment located above the first tray and is positioned to direct germicidal light toward the portable electronic devices located in the first slots. A second tray positioned in the compartment includes a plurality of second slots for receiving the portable electronic devices, wherein the second tray is positioned below the first tray and the first charging component. A second charging component positioned in the compartment includes a plurality of charging ports to charge portable electronic devices located in the second slots. A second germicidal lamp is positioned in the compartment located above the second tray and is positioned to direct germicidal light toward the portable electronic devices located in the second slots.

Further provided is a cart for holding a plurality of chargeable portable electronic devices having an enclosure providing a compartment. At least one tray is positioned in the compartment, wherein each tray includes a plurality slots for receiving the portable electronic devices. A plurality of charging ports in the compartment enable charging of the chargeable portable electronic devices disposed within the slots. At least one germicidal source positioned in the compartment is positioned to sterilize the chargeable portable electronic devices disposed in the slots when activated. A plurality of rollers at a bottom of the cart allow the cart to be movable on a surface.

### BRIEF DESCRIPTION OF THE DRAWINGS

Embodiments are described by way of example, with reference to the accompanying drawings, which are not drawn to scale, wherein:

FIG. 1 illustrates cut-away view of an embodiment of a compartment of the cart.

FIGS. 2, 3, and 4 illustrate a view of an embodiment of the compartment showing all the trays.

FIGS. 5 and 6 illustrate a partial view of an embodiment of the compartment showing the first two upper trays in the compartment.

FIG. 7 a view of a rear end of the cart.

### DETAILED DESCRIPTION

Embodiments provide a station to allow management of a large number of tablets and smartphones together. Described embodiments provide an efficient design of a cart to allow for the charging and disinfecting of numerous tablets and smartphones. The described arrangements are particularly useful for organizations that deploy a large number of portable electronic devices by allowing numerous portable electronic devices to be together charged and disinfected at a single station. The station may be mobile to allow movement to different locations.

Reference below will be made to the drawings wherein like structures may be provided with like reference designations. In order to show the structures of various embodiments most clearly, the drawings herein include diagrammatic representations of components of a charging station. Thus, the actual appearance of the charging station may appear different while still incorporating the claimed structures of the illustrated embodiments. Moreover, the drawings may show only the structures necessary to understand the illustrated embodiments. Additional structures known in the art have not been included to maintain the clarity of the drawings.

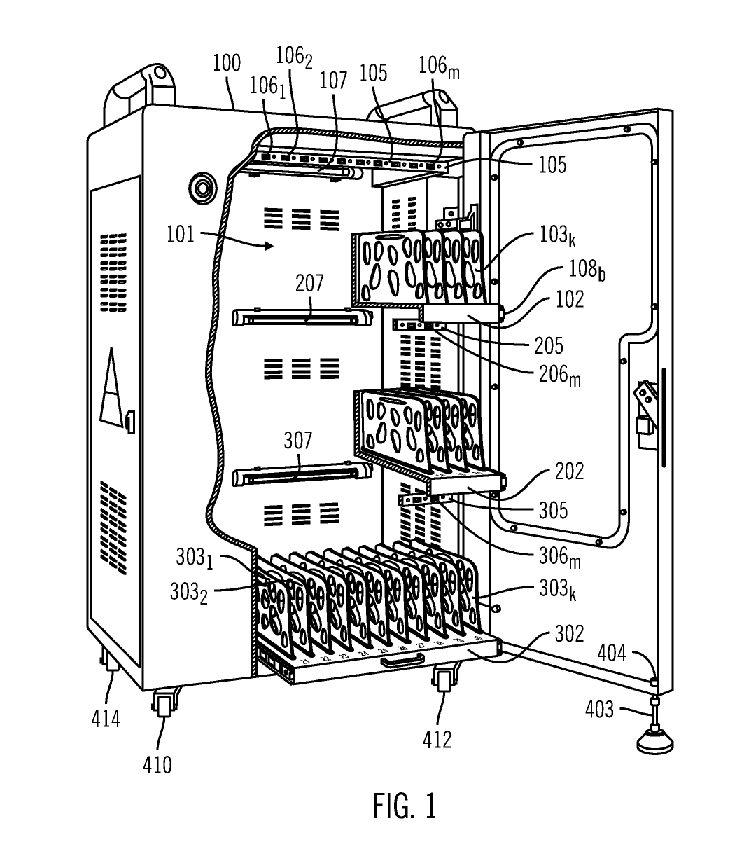

FIGS. 1-6 illustrate views of components of a cart 100 forming an enclosure providing a compartment 101. Disposed within the compartment 101 are a plurality of trays 102, 202, 302, where each tray has a plurality of vertical oriented dividers 103₁, 103₂ . . . 103ₖ, 203₁, 203₂ . . . 303ₖ, 303₁, 303₂ . . . 303ₖ. Each pair of adjacent dividers, e.g., 103₁, 103₂, forms a slot 104₁, 104₂ . . . 104ₘ, 204₁, 204₂ . . . 204ₘ, 304₁, 304₂ . . . 304ₘ in which a user may insert a portable electronic device, such as a smartphone and/or tablet. Further, the user may place other types of devices in the slots, other than chargeable electronic devices, to disinfect.

Positioned above an upper tray 102 and below the middle 202 and lower 302 trays are charging components 105, 205, and 305, respectively. The charging components 105, 205, and 305 may each comprise a charging strip, each strip having a plurality of charging ports 106₁, 106₂ . . . 106ₘ, 206₁, 206₂ . . . 206ₘ, 306₁, 306₂ . . . 306ₘ. Each of the charging ports 106₁, 106₂ . . . 106ₘ, 206₁, 206₂ . . . 206ₘ, 306₁, 306₂ . . . 306ₘ , may be electrically coupled via a cable to a portable electronic device within the slots 104₁, 104₂ . . . 104ₘ, 204₁, 204₂ . . . 204ₘ, 304₁, 304₂ . . . 304ₘ to charge the portable electronic devices while disposed within the slots 104₁, 104₂ . . . 104ₘ, 204₁, 204₂ . . . 204ₘ, 304₁, 304₂ . . . 304ₘ. The cart 100 may have a power connector to connect to a power source to provide current to the charging components 105, 205, and 305, which in turn supply power to the charging ports 106₁, 106₂ . . . 106ₘ, 206₁, 206₂ . . . 206ₘ, 306₁, 306₂ . . . 306ₘ.

In one embodiment, a cable may connect the portable electronic devices to the charging ports 106₁, 106₂ . . . 106ₘ, 206₁, 206₂ . . . 206ₘ, 306₁, 306₂ . . . 306ₘ. In an alternative embodiment, the charging ports 106₁, 106₂ . . . 106ₘ, 206₁, 206₂ . . . 206ₘ, 306₁, 306₂ . . . 306ₘ may comprise wireless charging devices to allow wireless charging of the portable electronic devices in the slots 104₁, 104₂ . . . 104ₘ, 204₁, 204₂ . . . 204ₘ, 304₁, 304₂ . . . 304ₘ.

In the embodiment of FIGS. 1-6, the trays 102, 202, 302 and charging components 105, 105, 305 are shown as separately formed. In an alternative embodiment, the charging ports may be formed integral in the trays 102, 202, 302. In yet further embodiments, the charging components 105, 205, 305 may be in locations in the compartment 101 other than directly above and below the trays 102, 202, 302. As shown in FIGS. 1-6, the slots 104₁, 104₂ . . . 104ₘ, 204₁, 204₂ . . . 204ₘ, 304₁, 304₂ . . . 304ₘ may be numbered to allow a user to more easily identify the slots including their devices.

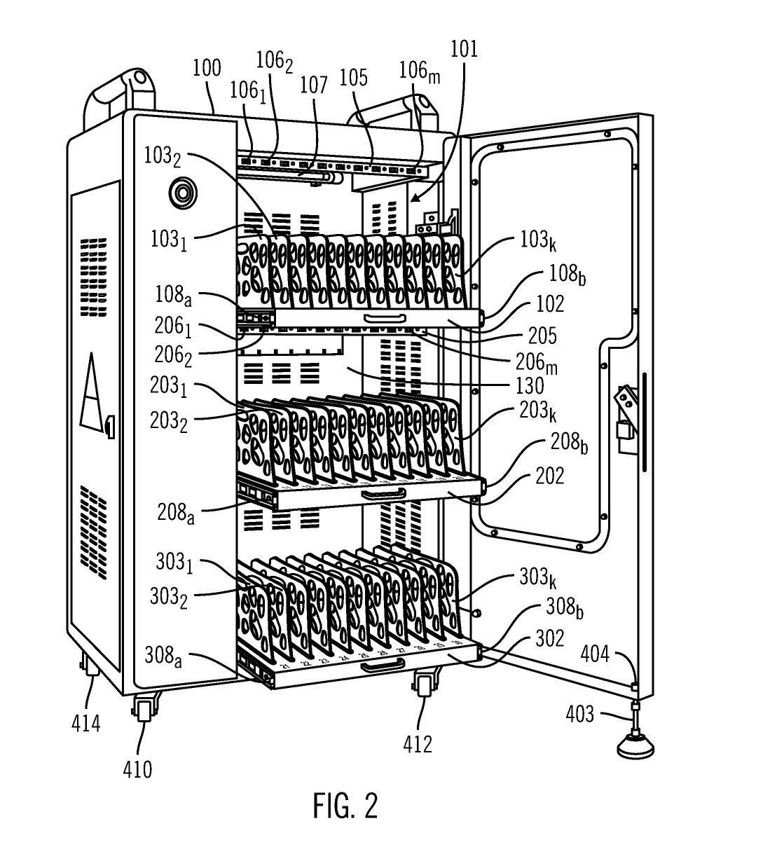

FIGS. 2-6 show each tray 102, 202, 302 as having a same number of dividers, slots, and corresponding charging ports. In alternative embodiments, the different trays 102, 202, 302 may have a different number of dividers, slots and charging ports.

In one embodiment there is one charging port 106₁, 106₂ . . . 106ₘ, 206₁, 206₂ . . . 206ₘ, 306₁, 306₂ . . . 306ₘ disposed directly above each slot 104₁, 104₂ . . . 104ₘ, 204₁, 204₂ . . . 204ₘ, 304₁, 304₂ . . . 304ₘ. In an alternative embodiment, there may be other arrangements of slots to charging ports, such as more than one charging port available for each slot, one charging port shared by multiple slots, etc.

FIGS. 1-6 show a germicidal source 107, 207, and 307 positioned above each of the trays 102, 202, 302, respectively, to disinfect any portable electronic devices disposed in slots 104₁, 104₂ . . . 104ₘ, 204₁, 204₂ . . . 204ₘ, 304₁, 304₂ . . . 304ₘ in the trays 102, 202, 302 positioned directly below the germicidal sources 107, 207, and 307. In one embodiment, the germicidal sources 107, 207, and 307 disinfecting multiple portable electronic devices in the slots may comprise germicidal lamps, such as a lamp producing ultraviolet light sufficient to destroy bacteria and germs. In one embodiment, each germicidal lamp 107, 207, and 307 may comprise a compact fluorescent lamp. The germicidal lamp 107, 207, 307 may be set to have a sufficient wavelength to destroy germs and bacteria and, at the same time not cause damage to the data stored in any electrically erasable programmable memory (EEPROM) in the smartphone or tablet device.

FIG. 1 provides a cut-away view of the trays 102, 202, 302, shown complete in other of the view of FIGS. 2-6, to allow a view of the back of the compartment 101 and regions and components below the trays, such as the lamps 107, 207 and 307.

In FIGS. 1-6, there is one germicidal lamp 107, 207, 307 that disinfects multiple electronic devices in the multiple slots 104₁, 104₂ . . . 104ₘ, 204₁, 204₂ . . . 204ₘ, 304₁, 304₂ . . . 304ₘ in one of the trays 102, 202, 302. However, in further implementations additional lights can be added so that multiple germicidal lamps generate light directed toward one of the trays 102, 202, 302.

In the embodiments shown in FIGS. 1-6, each of the dividers 103₁, 103₂ . . . 103ₖ, 203₁, 203₂ . . . 303ₖ, 303₁, 303₂ . . . 303ₖ includes a plurality of holes formed in the divider structure. This arrangement of holes or openings in the dividers allows the germicidal lamp 107, 207, 307 light to contact surfaces of the back and front sides of the portable electronic devices disposed in the slots 104₁, 104₂ . . . 104ₘ, 204₁, 204₂ . . . 204ₘ, 304₁, 304₂ . . . 304_{m to} and disinfect the back and front sides of the portable electronic devices.

In one embodiment, the dividers 103₁, 103₂ . . . 103ₖ, 203₁, 203₂ . . . 303ₖ, 303₁, 303₂ . . . 303ₖ may be permanently affixed to the trays 102, 202, 302. In a further embodiment, the dividers 103₁, 103₂ . . . 103ₖ, 203₁, 203₂ . . . 303ₖ, 303₁, 303₂ . . . 303ₖ may be removably affixed to the trays 102, 202, 302. This allows a broken divider to be replaced and for the use of different size dividers for different sized portable electronic devices. For instance, for a smaller device, a smaller divider having less height may be inserted in the tray 102, 202, 302 in place of a larger and higher divider to increase the exposure of the smaller electronic device to the light from the germicidal source 107, 207, 307.

For each of the trays 102, 202, and 302 there is a pair of tracks 108a, 108b, 208a, 208b, 308a, 308b in which rails affixed to the side of the trays 102, 302, and 202 are inserted to allow the trays 102, 302, and 202 to slide outward from the compartment 101 away from a back wall 130 (FIGS. 2, 5, 6) of the compartment 101.

Sliding the trays 102, 302, and 302 outward from the compartment 101 provides ease of access to the slots slot 104₁, 104₂ . . . 104ₘ, 204₁, 204₂ . . . 204ₘ, 304₁, 304₂ . . . 304ₘ for inserting or removing portable electronic devices.

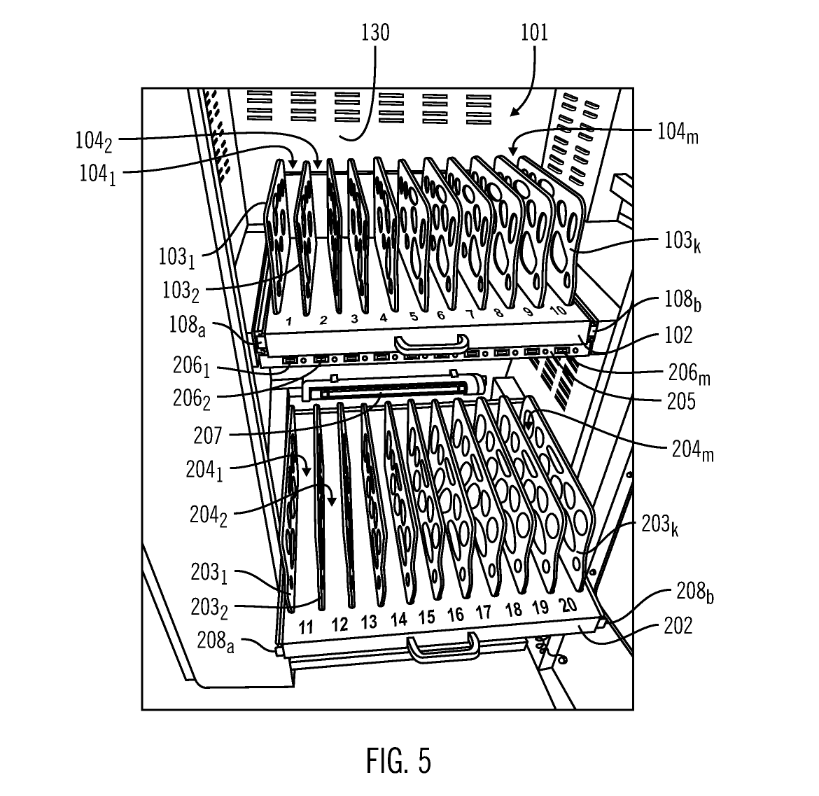

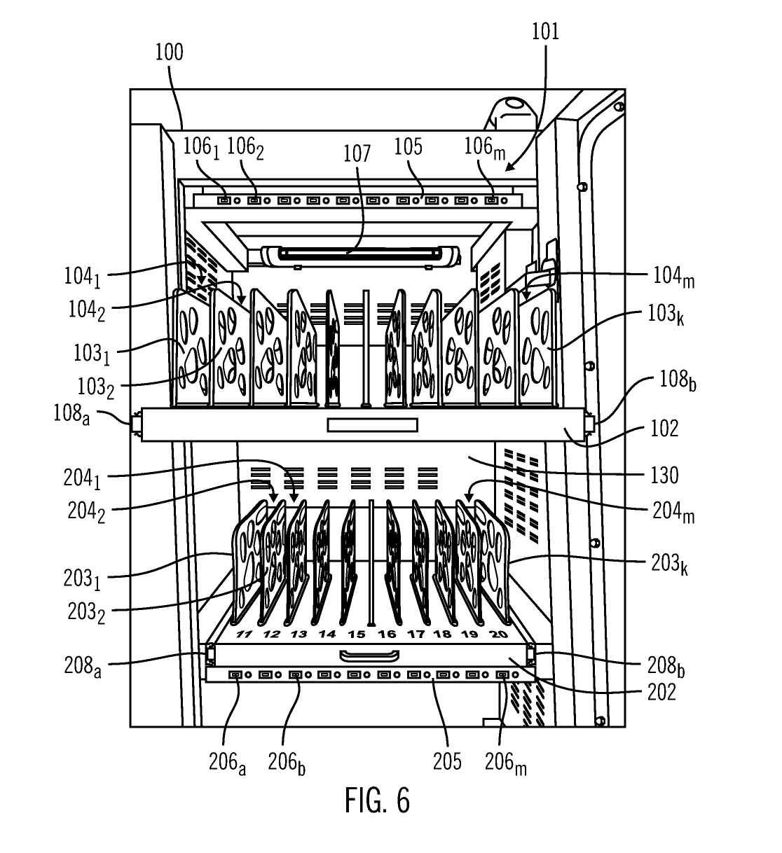

In one embodiment, as shown in FIGS. 1 and 6, the first germicidal source 107 for the first or upper tray 101 is located behind the upper charging component 105 power strip. FIGS. 1 and 5 show that the germicidal sources 207 and 307 for the middle 201 and lower 301 shelves may be located under the tray 202, 302 and behind the charging strips 205, 207.

FIGS. 1 and 5 illustrate the embodiment of the middle lamp 207 below tracks 208a, 208b in which the tray 202 is slideably inserted. When the tray 102, 202 is slid inward toward the back wall 130, the underside of the trays 102, 202 cover un upper side of the lamps 207, 307, shown as 232, and deflect light from the lamps 207, 307 downward toward trays 202 and 302 to disinfect electronic devices disposed therein.

As shown in FIGS. 1 and 5, the germicidal lamps 207, 307 are located in a space defined at the rear of the compartment 101 by a rear section of the tracks 208a, 208b, the back wall 130 (FIG. 2), and the bottom side of the tray 102, 202 when the tray 201, 302 is slideably moved along the tracks 208a, 208b to the back wall 130.

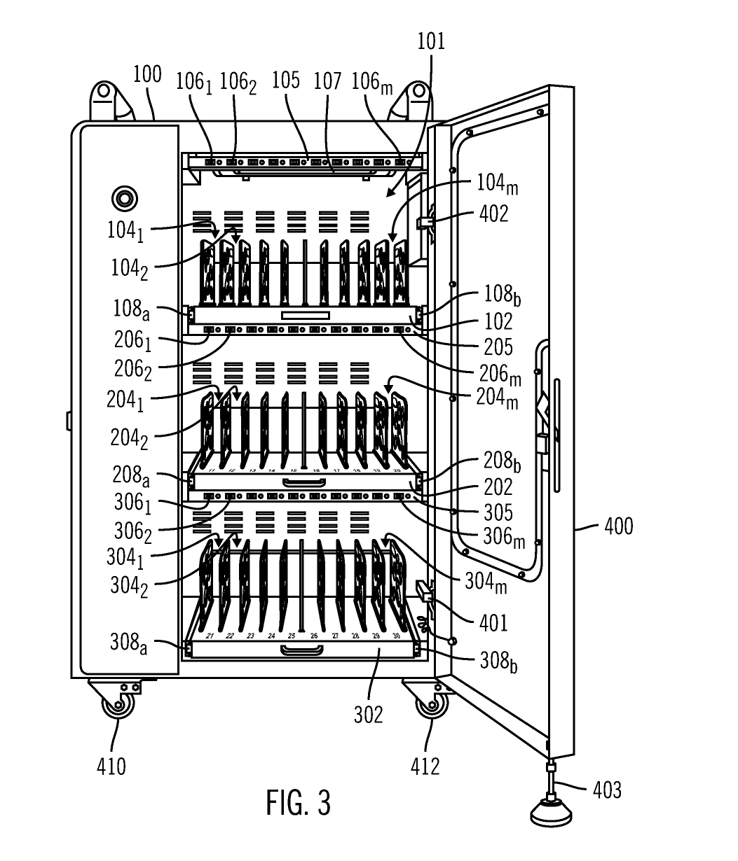

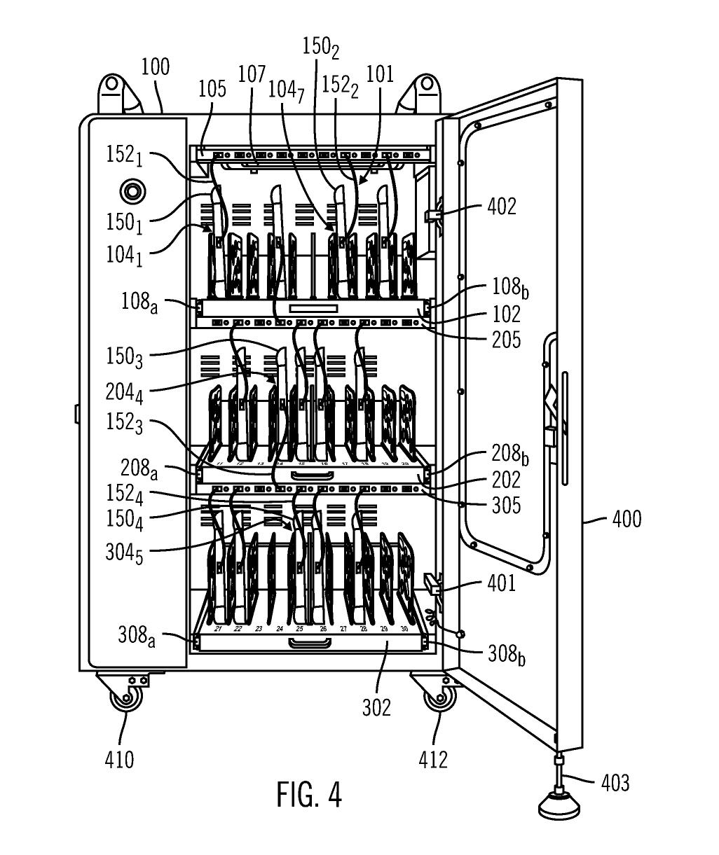

FIGS. 1, 2, 5, 6 show the trays 102, 202, 302 slid outward on the tracks away from the back wall 130 and FIGS. 3 and 4 show the trays 102, 202, 302 slid inward toward the back wall 130.

FIG. 4 shows tablet devices e.g., 150₁, 150₂, 150₃, 150₄ disposed within slots 104₁, 104₄, 104₇, 104₉ each having a cable, 152₁, 152₂, 152₃, 152₄, such as a Universal Serial Bus (USB) cable, or other types of charging cables, cable, to connect to charging ports 106₁, 106₇, 306₄, 306₅. Tablets 150₁, 150₂, 150₃, 150₄ disposed in the slots 104₁, 1047, 204₄, 304₅ may be plugged into a charging port 106₁, 106₂ . . . 106ₘ, 206₁, 206₂ . . . 206ₘ, 306₁, 306₂ . . . 306ₘ on a charging component 105, 205, 305 above or below the slot.

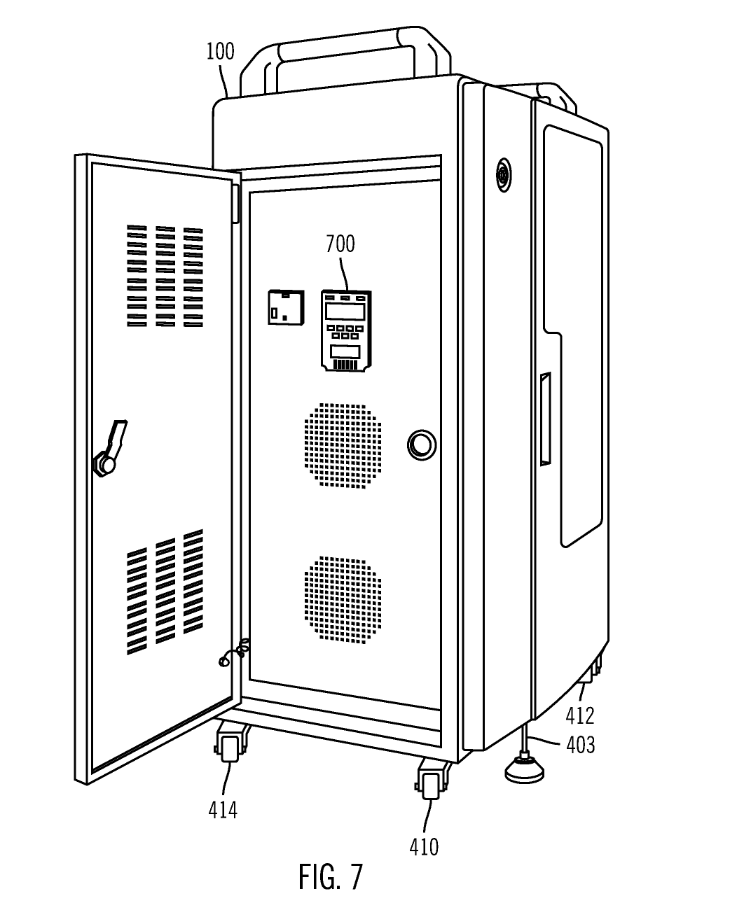

FIGS. 1-6 show a door 400 hingedly connected at hinges 401, 402 (FIG. 3) to a side of the compartment 101 to cover the compartment 101 in a closed position. As shown in FIGS. 2, 3, and 4 the door 400 has a retractable leg 403 that may be moved upward or downward to provide a support for the door to prevent the cart 100 from tipping over when the door 400 is in an open position or in a closed position as shown in FIG. 7. In the embodiment of FIGS. 2, 3, 4, the retractable leg 403 may have an external thread to allow the leg 403 to mate with and screw into an internal thread in an opening 404 of the door 400 through which the retractable leg 403 extends.

FIGS. 2, 3, 4 further show the cart 100 as having wheels or rollers 410, 412, 414, 416 to allow the cart 100 to be movable on a surface. The retractable leg 403 may be moved upward when the cart is moved so as not to interfere with the movement of the cart 100.

FIG. 7 shows a rear view of the cart 100, opposite the side of the opening to the compartment 101 having a timer interface 700. The user may manipulate the buttons on the timer interface 700 to schedule the germicidal sources 107, 207, 307 to activate at a particular scheduled time period, e.g., hour, day, month, etc., for a selected time duration. The timer interface 700 may include circuitry to activate and deactivate the germicidal sources 107, 207, 307 during a scheduled time period to disinfect. The timer interface 700 may allow the germicidal sources 107, 207, 307 to be separately scheduled to activate or to activate together for one scheduled time. In one embodiment, the germicidal sources 107, 207, 307 may activate, such as emitting germicidal light, regardless of whether the door 400 is in the open or closed position. In alternative embodiment, the germicidal sources 107, 207, 307 may be prevented from activating if the door 400 is in the open position, and the germicidal light may only activate if the door 400 is closed shut.

The timer interface 700 may include circuitry to perform timer operations. The timer interface 700 has circuitry to receive a user scheduling setting to activate the at least one germicidal source 107, 207, 307 during a time period. The user may through the interface 700 schedule an activation of one or more of the germicidal sources 107, 207, 307 during a selected time period. In response to determining a beginning of the scheduled time period, the timer interface 700 circuitry may activate the germicidal sources 107, 207, 307 to sterilize the chargeable portable electronic devices disposed in the slots for a duration of the time period when the door is positioned in one of the open position and the closed position. The germicidal sources 107, 207, 307 may be deactivated after the scheduled time period has expired.

In further embodiments, the charging ports 106₁, 106₂ . . . 106ₘ, 206₁, 206₂ . . . 206ₘ, 306₁, 306₂ . . . 306ₘ may further comprise an interface to allow communication with an external computer. In such case, the cart 100 would have a network interface, such as a Local Area Network (LAN) adaptor or some other interface, such as a serial or Universal Serial Bus (USB) interface to allow an external computer to communicate with a portable electronic devices disposed in the slots and connected to the charging ports 106₁, 106₂ . . . 106ₘ, 206₁, 206₂ . . . 206ₘ, 306₁, 306₂ . . . 306ₘ. An administrator may then apply updates to the electronic devices connected via the charging ports to allow updating of programs and firmware in the electronic devices while the devices are being disinfected by the germicidal sources 107, 207, 307.

Terms such as “top”, bottom”, “upper”, “lower”, “rear”, “front”, “back”, “outer”, “inner”, “bottom”, “left”, and the like may be used for descriptive purposes only and are not to be construed as limiting. Embodiments may be manufactured, used, and contained in a variety of positions and orientations.

The variable reference numerals, such as k, m, and n may indicate a variable number of instances of an element, and may represent the same or different number of instances when used with different instances of the same or different reference numerals.

In the foregoing Detailed Description, various features are grouped together for the purpose of streamlining the disclosure. This method of disclosure is not to be interpreted as reflecting an intention that the claimed embodiments of the invention require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate preferred embodiment.

While certain exemplary embodiments have been described above and shown in the accompanying drawings, it is to be understood that such embodiments are merely illustrative and not restrictive, and that embodiments are not restricted to the specific constructions and arrangements shown and described since modifications may occur to those having ordinary skill in the art.

What is claimed:

1. A system for holding a plurality of chargeable portable electronic devices, comprising:
an enclosure providing a compartment;
at least one tray positioned in the compartment, wherein each tray includes a plurality of slots for receiving the portable electronic devices;
a plurality of charging ports in the compartment to enable charging of the chargeable portable electronic devices disposed within the slots; and
a germicidal source positioned in the compartment to sterilize a plurality of the chargeable portable electronic devices disposed in the slots when activated.

2. The system of claim 1, wherein the system comprises:
a door hingedly connected to the enclosure that in a closed position covers an opening to the compartment to seal the compartment and that in an open position enables access to add or remove chargeable portable electronic devices from the slots.

3. The system of claim 2, further comprising:
a timer device accessible on an outside of the enclosure, having circuitry to perform operations, the operations comprising:
receiving a user schedule setting to activate the germicidal source during a time period;
scheduling an activation of the germicidal source during the time period; and
in response to determining a beginning of the time period, activating the germicidal source to sterilize the chargeable portable electronic devices disposed in the slots for a duration of the time period when the door is positioned in one of the open position and the closed position.

4. The system of claim 1, wherein each of the charging ports are aligned with one of the slots.

5. The system of claim 1, wherein there are a plurality of trays and there are a plurality of germicidal sources, and wherein for each of the trays there is one germicidal source positioned to sterilize chargeable portable electronic devices in the tray, and wherein different of the germicidal sources are used to sterilize chargeable portable electronic devices in slots in different of the trays.

6. The system of claim 1, wherein the germicidal source comprises a germicidal lamp that produces germicidal light capable of destroying bacteria, and wherein each of the germicidal lamp is positioned in the compartment to direct light into the slots of the at least one tray to sterilize any chargeable portable electronic devices in the tray.

7. The system of claim 6, wherein there are a plurality of trays, wherein there is one germicidal lamp positioned above each of the trays and the slots in the tray to direct germicidal light onto the chargeable portable electronic devices in the tray, and wherein different of the germicidal lamps are positioned above different of the trays.

8. The system of claim 6, wherein the slots are formed of dividers positioned on the trays, wherein the dividers have holes formed therein through which germicidal light may pass to contact the portable chargeable portable electronic device disposed therein.

9. The system of claim 1, further comprising:
at least one charging component associated with the at least one tray, wherein each of the at least one charging component includes the charging ports to charge the chargeable portable electronic devices disposed in the slots of the associated tray.

10. The system of claim 9, wherein in each of the at least one charging component there is one separate charging port for each of the slots in the tray to charge portable electronic devices disposed in the slots in the tray.

11. A system for holding a plurality of chargeable portable electronic devices, comprising:
an enclosure providing a compartment;
a first tray positioned in the compartment including a plurality of first slots for receiving the portable electronic devices;
a first charging component positioned in the compartment including a plurality of charging ports to charge portable electronic devices located in the first slots;
a first germicidal lamp positioned in the compartment located above the first tray and positioned to direct germicidal light toward the portable electronic devices located in the first slots;
a second tray positioned in the compartment including a plurality of second slots for receiving the portable electronic devices, wherein the second tray is positioned below the first tray and the first charging component;
a second charging component positioned in the compartment including a plurality of charging ports to charge portable electronic devices located in the second slots;
a second germicidal lamp positioned in the compartment located above the second tray and positioned to direct germicidal light toward the portable electronic devices located in the second slots.

12. The system of claim 11, wherein the first charging component includes one port for each of the slots in the first tray, and wherein the second charging component includes one port for each slot in the second tray.

13. The system of claim 11, wherein the first charging component is located above the first tray in the compartment and wherein the second charging component is located above the second tray in the compartment.

14. The system of claim 11, further comprising:
first tracks on side walls of the compartment positioned above the second charging component, wherein sides of the first tray are inserted into the first tracks to allow the first tray to slideably move in the first tracks; and
second tracks on the side walls of the compartment, wherein sides of the second tray are inserted into the second tracks to allow the second tray to slideably move in the second tracks.

15. The system of claim 11, further comprising:
an opening defined by a side of the first charging component, an inner wall of the compartment, and a portion of the first tray positioned, wherein the second germicidal lamp is disposed in the opening to direct germicidal light downward toward the second slots.

16. The system of claim 15, wherein the first germicidal lamp is located at an upper wall of the compartment.

17. The system of claim 11, wherein the system comprises:
a door hingedly connected to the enclosure that in a closed position covers an opening to the compartment to seal the compartment and that in an open position enables access to add or remove chargeable portable electronic devices from the slots.

18. The system of claim 11, further comprising:
a third tray positioned in the compartment including a plurality of third slots for receiving the portable electronic devices;
a third charging component positioned in the compartment and located below the second tray including a plurality of charging ports to charge portable electronic devices located in the third slots;
a third germicidal lamp positioned in the compartment located above the third tray and positioned to direct germicidal light toward the portable electronic devices located in the second slots.

19. The system of claim 18, further comprising:
third tracks on the side walls of the compartment, wherein sides of the third tray are inserted into the third tracks to allow the third tray to slideably move in the third tracks; and
an opening defined by a side of the second charging component, the inner wall of the compartment, and a portion of the second tray positioned, wherein the third germicidal lamp is disposed in the opening to direct germicidal light downward toward the third slots.

20. The system of claim 11, wherein the slots are formed of dividers positioned on the trays, wherein the dividers have holes formed therein through which germicidal light may pass to contact the portable chargeable portable electronic devices disposed therein.

21. A cart for holding a plurality of chargeable portable electronic devices, comprising:
an enclosure providing a compartment;
at least one tray positioned in the compartment, wherein each tray includes a plurality slots for receiving the portable electronic devices;
a plurality of charging ports in the compartment to enable charging of the chargeable portable electronic devices disposed within the slots;
at least one germicidal source positioned in the compartment positioned to sterilize the chargeable portable electronic devices disposed in the slots when activated; and
a plurality of rollers at a bottom of the cart to allow the cart to be movable on a surface.

22. The cart of claim 21, wherein the system comprises:
a door hingedly connected to the enclosure at hinges that in a closed position covers an opening to the compartment to seal the compartment and that in an open position enables access to add or remove chargeable portable electronic devices from the slots; and
a retractable leg on a lower corner of the door opposite a side of the door connected to the hinge, wherein the retractable leg in a first position extends substantially a same length as a wheel, wherein the retractable leg in the first position provides support for the cart.
